(19) United States
(12) Patent Application Publication
(10) Pub. No.: US 2020/0126173 A1
(43) Pub. Date: Apr. 23, 2020

(54) METHOD AND APPARATUS FOR BLOCKCHAIN ASSISTED DYNAMIC CONTRACT ADJUSTMENT

(71) Applicant: FORD GLOBAL TECHNOLOGIES, LLC, Dearborn, MI (US)

(72) Inventors: Abraham MEZAAEL, Southfield, MI (US); Jeffrey Scott BLAIR, South Lyon, MI (US); John Naum VANGELOV, South Lyon, MI (US); Aziz MAKKIYA, Troy, MI (US)

(21) Appl. No.: 16/165,705

(22) Filed: Oct. 19, 2018

(51) Int. Cl. G06Q 50/18; G07C 5/00; H04L 9/06

(52) U.S. Cl. CPC G06Q 50/188; H04L 2209/38; H04L 9/0618; G07C 5/008

(57) ABSTRACT

A system includes a processor configured to, responsive to a request for data modification, present available data options. The processor is also configured to, responsive to selection of a data option, present a consideration modification. Further, responsive to a user data option election, the processor is configured to present an amended agreement reflecting the consideration modification. The processor is additionally configured to, responsive to user agreement to the amended agreement, create a revised document and create a time ordered, sequentially linked record of the request, selection, election, respective responsive presentations, agreement and creation.

The illustrative embodiments generally relate to methods and apparatuses for blockchain-assisted dynamic contract adjustment.

### BACKGROUND

There is an increasing demand for on-demand data provision, with regards to vehicle data. Fleet managers, and even individual users, may want to receive certain types and volumes of data with regards to vehicles under their control, and the costs of obtaining and providing this data can be accommodated by an agreement between an original equipment manufacturer (OEM) and a recipient.

While the agreement may work fine to service an initial arrangement, if there are costs associated with types and volumes of data, changing recipient needs mean that the contract has to be renegotiated and resigned. This process can be cumbersome if needs are constantly changing, and it may become difficult for a user or original equipment manufacturer (OEM) to keep track of which contract currently applies.

### SUMMARY

In a first illustrative embodiment, a system includes a processor configured to, responsive to a request for data modification, present available data options. The processor is also configured to, responsive to selection of a data option, present a consideration modification. Further, responsive to a user data option election, the processor is configured to present an amended agreement reflecting the consideration modification. The processor is additionally configured to, responsive to user agreement to the amended agreement, create a revised document and create a time ordered, sequentially linked record of the request, selection, election, respective responsive presentations, agreement and creation.

In a second illustrative embodiment, a method includes detecting occurrence of a condition affecting one or more existing agreements. The method also includes determining to which existing agreements the condition applies. The method further includes notifying a party to the each determined agreement of a needed modification. The method also includes sending modified versions of each determined agreement reflecting the modification. Further, the method includes receiving acknowledgement of modified-version receipt. Additionally, the method includes receiving acceptance or rejection from the party and creating a time ordered, sequentially linked record of the notifying, sending, receiving acknowledgment, and receiving acknowledgement/rejection.

In a third illustrative embodiment, a non-transitory computer readable storage medium stores instructions that, when executed by a processor, cause the processor to perform the method including detecting occurrence of a condition affecting one or more existing agreements. The method also includes determining to which existing agreements the condition applies. The method further includes notifying a party to the each determined agreement of a needed modification. The method also includes sending modified versions of each determined agreement reflecting the modification. Further, the method includes receiving acknowledgement of modified-version receipt. Additionally, the method includes receiving acceptance or rejection from the party and creating a time ordered, sequentially linked record of the notifying, sending, receiving acknowledgment, and receiving acknowledgement/rejection.

### BRIEF DESCRIPTION OF THE DRAWINGS

FIG. 1 shows an illustrative vehicle computing system;

FIG. 2 shows an illustrative process for contract generation;

FIG. 3 shows an illustrative process for data reporting; and

FIG. 4 shows an illustrative process for contract modification.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

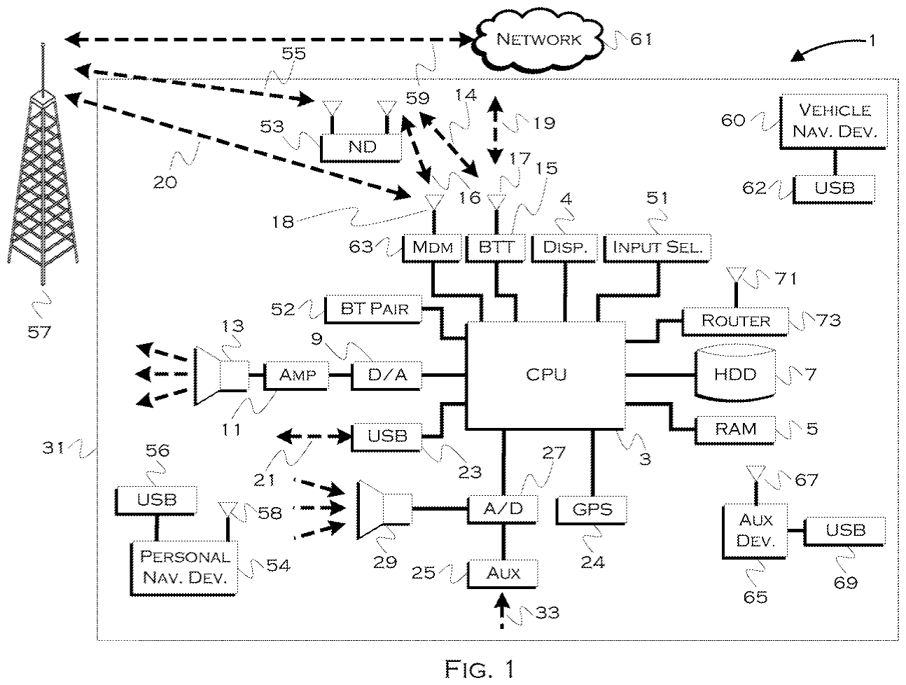

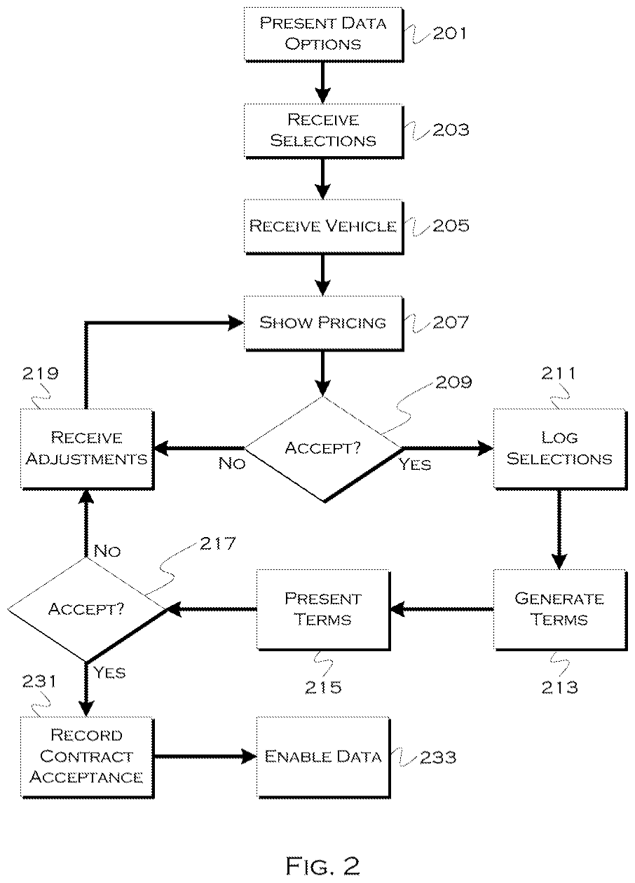

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the interne, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

By leveraging on-demand contract adjustment, in a secure, trackable and demonstrable manner, the illustrative concepts and embodiments provide opportunities to improve the utility and functionality of traditional data delivery agreements. The novel, uncommon and atypical examples and concepts described herein demonstrate potential improvements achievable through use of those examples, concepts, and the like.

Many users, maintenance centers and fleet managers have varied uses for vehicle data. Fleet managers may want stock data (of certain types) for a wide number of vehicles. Insurance companies may want similar reporting, or reporting of particular incidents or occurrences. Maintenance centers may want data on certain customer's vehicles (with customer permission) and/or for inventory management purposes.

An automotive original equipment manufacturer (OEM) is in a good position to provide a variety of vehicle data, having full access to a vehicle data bus and electronic control units (ECUs). While this data may be provided to direct customers as a free services, especially when those customers need the data infrequently, providing data to a fleet manager or insurance company may require increased server load and servicing, and thus such data may carry a cost.

Currently, contracts can be negotiated and accommodate given data needs of a data requestor. These may specify, among other things, data volumes, frequency of reporting, types of data, duration of reporting, etc. Each contract term may affect the overall price, and the totals can be fairly large for a large fleet. That is, if a fleet manager is responsible for 1,000 vehicles, and each vehicle carries a $20 monthly data-reporting cost, the fleet manager has an interest in reducing this price based on alleged non-delivery of data. Or, if the fleet manager wants to change contract terms, data must be delayed or suspended while the contract is modified. This can present unacceptable delays in the processing of new terms, and can create gaps in the data record, result in irritated customers, and reduce overall sale of easily accessible data.

Through the use of blockchain-enabled smart contracts, the illustrative embodiments can improve contract processing throughput, enable on-the-fly changes, and generally “prove” the provision of both data and suggested or necessary contractual changes. This can remove arguments about what was or was not presented or agreed to, and further allows for dynamic and on-the-fly redefinition of terms as data or fleet manager needs change.

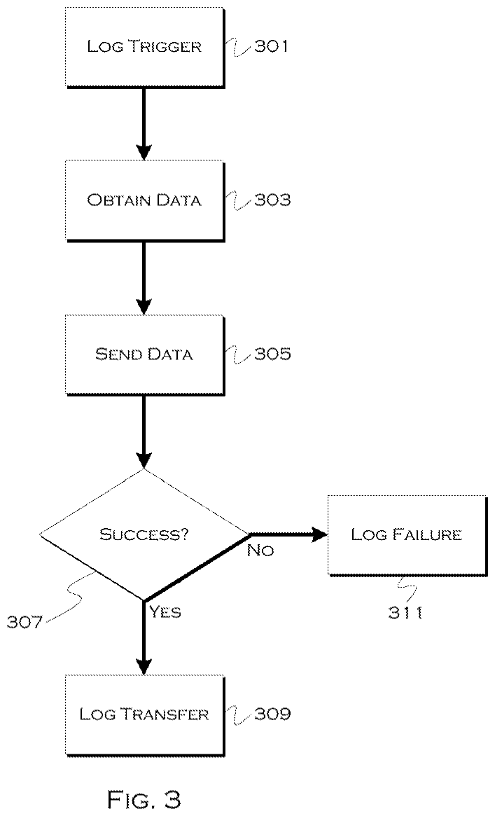

FIG. 2 shows an illustrative process for contract generation. In this illustrative embodiment, a new contract may be generated that specifies the terms of a data-provision agreement. Any number of terms can be defined, including, but not limited to, types of data, frequency of reporting, price of data, price per vehicle, duration of reporting, data usage caps, etc.

These are terms that would traditionally be presented in a contract, and each may require individual negotiation. If a given term is going to change, the contract might require renegotiation or signature, or negotiation and signature of a modification document. Even if the data prices are fixed, which is to say that little actual negotiation may occur, it could require significant time and effort to proceed with repeated negotiations and presentation of alternative pricing. The OEM negotiator may have to constantly check back with a reporting entity to determine the current prices for proposed changes, and generally, valuable time is wasted and valuable revenue is lost.

By using a blockchain-secured contract, a number of verification points can be easily tracked and recorded, allowing for real-time contract renegotiation on an as-needed basis. Because presentation of terms, selection of items, agreement of terms, signature of contract, etc. can all be recorded as blockchain events, a robust record can be developed that allows fleet managers to change data requests dynamically and provides the data-providing OEM with proof of the requested changes, as well as proof of presentation of terms and proof of agreement to terms.

Similar methods can be used to track delivery of data elements and/or legal changes to terms, or terminations on behalf of the client. Again, as the blockchain is a highly secure and demonstrable chain of events, fears about unagreed-to terms, unsigned papers and/or undelivered data can be mitigated. Further, if the record does indicate that certain data was not delivered, the OEM can issue a refund with confidence that they are not being lied to about the data delivery and receipt.

In this example, the process presents 201 a list of selectable or configurable data options. This can include, for example, driving with diagnostic trouble cods active, fuel efficiency, tire pressure, average speed, average stop time, etc. The vehicle can track virtually any travel related data, and the OEM can elect to sell or give this data to outside parties. If the party receiving the data is not the owner of the vehicle, the data may be scrubbed of identifying characteristics. The receiving party has some assurances about the validity of the data, if the data is stamped as park of the blockchain whenever it is gathered and received. This can alleviate any fears about an OEM creating false data.

The interested user selects the data of interest and the process receives 203 the selection of various data elements. Data can be defined per vehicle, per class, per fleet, etc. If certain vehicles in a class or fleet lack a reporting or gathering function for requested data, the pricing for the data can reflect this. The manager can be shown a copy of the notice that certain vehicles will not have certain data reported therefore, and the manager can agree. Both the provision of the information and the agreement thereto can be stamped into the blockchain.

The process may also receive 205 a set of vehicle identifications (IDs) (e.g., vehicle identification numbers (VINs) or other unique identifiers) identifying which vehicles will have data gathered therefrom. Based on difficulty or rarity of data, size of requests, frequency of requests, etc., the OEM can model pricing for the aggregate request and show the pricing 207 to the fleet manager. If the fleet manager does not accept 209, the manager can modify the data selections (e.g., fewer vehicles, less frequent reporting, etc.) 219 in a suitable manner until the price is acceptable. Presentation of the price, as well as any rounds of modification, can all be recorded as part of the blockchain, so both OEM and client know exactly who did what, when, and who saw what, when. This should avoid virtually any arguments about whether a change was made or whether a price was displayed.

Once the fleet manager accepts the pricing, the process may create 211 a blockchain record of the accepted selections and generate 213 the final terms for the contract. This can include a variety of language that is commonly in a contract, and this language can be modified to include the selections and pricing terms agreed upon. The process can then present 215 all terms (e.g., on a human machine interface, via email, via electronic document, etc). and wait for acceptance 217. Again, the fleet manager may choose to make amendments after viewing the full contract, and thus the process can repeat until a fully satisfactory contract is developed and accepted 217.

Upon acceptance of the terms, the process can record 231 display of the terms and acceptance of the terms as part of the blockchain. At this point, the chain may include a full record of every selection, change, presentation of data and acceptance that occurred while formulating the contract. As such, it is effectively a timestamped secure record of the entire digital negotiation. One the contract is recorded, the process can enable 233 the flow of data from the vehicle(s) to the fleet manager or customer.

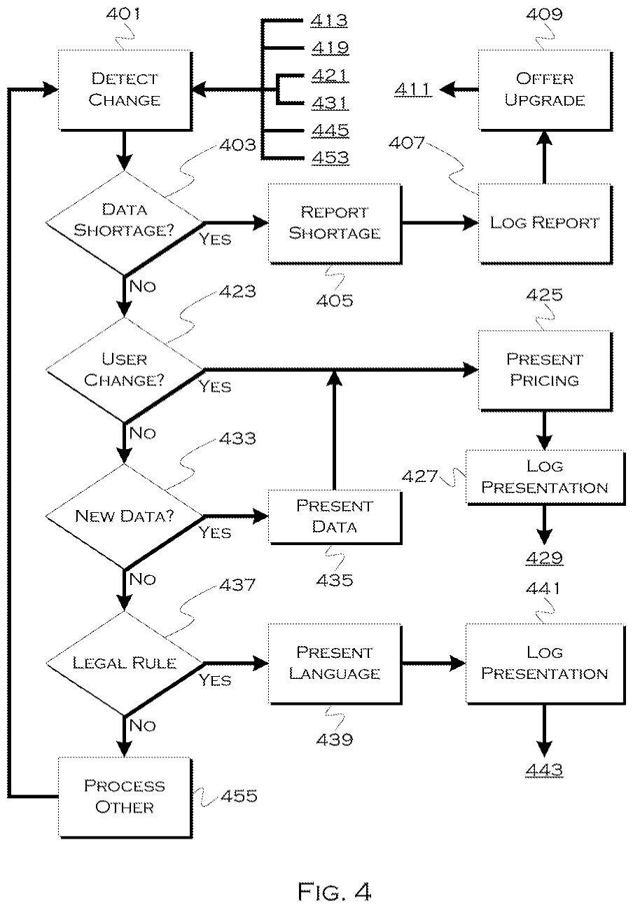

FIG. 3 shows an illustrative process for data reporting. This is a process that may occur each time data is reported, when data is gathered and/or when data is reported in a batch. Recordation, transportation, receipt and presentation of the data can all be logged as separate chain events, effectively allowing a full record of the flow of data and an easy determination whether an error occurred and where the error occurred.

The process can record 301 a trigger event, which can be, for example, the passage of prespecified time, a vehicle achieving a certain state (speed, brake, park, etc.), or the occurrence of a specific event (e.g., (diagnostic trouble code (DTC) or accident). The detected occurrence of the event, along with an event identifier, can be logged, so that a client can be informed as to why a certain data gathering event occurred if the client later questions the reason for providing the data.

The process can then obtain 303 the data related to the trigger, based on a predefined request from the customer or fleet manager which defines what data should be gathered in response to what trigger. The process can log obtainment of the data (verifying the packet was successfully gathered) and then send 305 the data to a remote customer. The sending of the data can also be logged as part of the chain, and the receipt of the data can be logged as well. If the transfer is successful 307, the process can log 309 the successful transfer of the data as requested, and if the transfer failed the process can log the failure of the requested transfer.

Any transactions that may incur a cost or require a record can be logged as part of a blockchain, which can include a blockchain established for engagement, creation, modification, fulfilment and completion of a given business relationship.

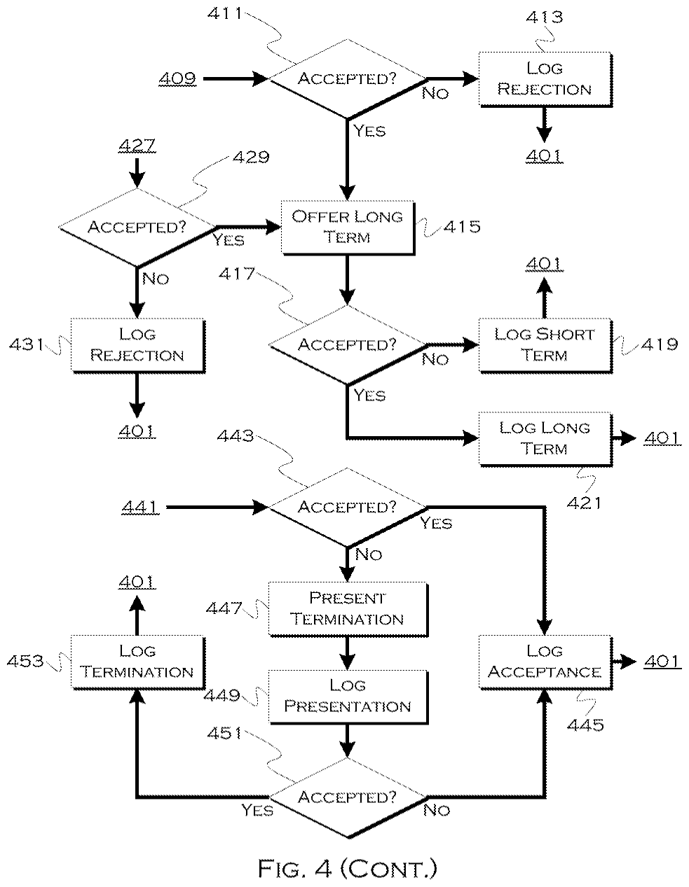

FIG. 4 shows an illustrative process for contract modification. This process describes non-limiting examples of how a contract may be modified, along with potential reasons for modification and processes to record modification request or efforts. This can include, for example, changes in needed data, modifications for a fleet or an individual vehicle, a legal change requiring a resigning of a document, an offering of a new data point, an approach of a data-cap, etc.

For example, if the process detects 401 a predefined change, change state, request for change, etc., the process may undergo a series of steps such as those illustratively shown. If the change relates to a data shortage 403, the customer may be approaching a data cap associated with an account. An OEM may not know how much total data is required to fulfil a contract, or the client may have data limits as a separately negotiated component of the contract. In some examples, the client may merely be limited by a data cap, and may be able to request as much data as is desired within the cap.

In virtually any instance, reaching a data cap and ceasing data transmission represents a loss of data to the client and loss of sales to the OEM. Thus, it is in everyone's best interest to renegotiate a data cap for either the current month or on a longer-term basis. If such a negotiation were undertaken in person, it could take significant time, and further there could be limits on an ability to modify terms, respond to proposed modifications, and demonstrate who saw what, when. It can be difficult to demonstrate that a given document or offering was shown to a customer, especially if the customer does not actually sign the document, and therefore the blockchain can help in this manner because records of documents being shown on a customer display or delivered to a customer can be timestamped as part of the blockchain.

Thus, for example, an OEM can demonstrate that two notifications regarding data limits were sent and displayed on given dates, that a rejection to the offer was received each time, that offers to extend the limits for the month or on a longer-term were shown and rejected, etc. This can help mitigate accusations from customers and absolve the OEM of any purported responsibility for allegedly failing to assist the customer or client. Also, the process can send a notification about the change, track the notification, send a modified contract proposal to the same or a different device, track both the sending and receipt (or opening) of the modified document, etc.

If the change-trigger relates to a data shortage 403, the process may report 405 the shortage to the client, and log 407 the reporting of the change. This creates a record of the showing of the shortage to the client, and the record can include where the message was delivered, when it was received and potentially even when it was shown.

The process may also offer 409 a data upgrade, which can include a new volume of data, or an offer to simply uncap the data for the duration of a specified period, so that an accurate measure of needed data can be obtained, and then the bill can be resolved at the end of the period. Since periodic billing updates can also be presented and logged, the aggregate effect of uncapping data (in terms of cost to client) can be mitigated because the client is knowingly shown the ongoing cost and can opt out in any time. And such all incidents of reporting can be logged, the client can hardly complain that anything was provided without ongoing consent.

If the offer to modify the data is not accepted 411, the process may log the rejection as evidence that the client refused the data-extension. The client may be given several opportunities to reject the data extension before the data is discontinued for the time period, and after these offers the client may specifically have to request a data extension in order to enable the data reporting.

If the offer to extend the data is accepted for the current period, the process may also offer 415 the extension on a longer-term basis. That is, the customer can accept the change for a longer prior or multiple reporting periods, and the confirmation of this acceptance 417 can be logged 419 so that the OEM can demonstrate that the client accepted the longer-term deal. If only the shorter-term offer is desired, the process can log the shorter-term deal acceptance. Again, each acceptance and/or rejection of any offer can be logged and timestamped securely as part of a chain, meaning that terms can be changed and agreed to on the fly, and as long as each side is fulfilling its stated obligations, there is a clear chain of evidence that neither side agreed to or failed to deliver something to which the other side later objects.

In other instances, a user may change 423 the requested data. This could be a request for an increase of data about a single vehicle, a known malfunction, a given driver, a group of vehicles, or new or increased/decreased frequency of reporting of already-requested data.

In this example, the process may present 425 pricing for the new data, which can include logging 427 the presentation both to prove the offer was made and to create a record of pricing in case there is later a question about an invoice. If the user accepts the new data pricing 429, then as with the data volume extension, the process can offer both a short-term option and a long-term permanent or longer extension of the newly requested data.

Once again, records of the long-term and short-term offers, agreement with the long term and short term offers, records of terms, records of delivery, etc., can be logged by the process to create verification of delivered offers and records of acceptance and viewing. Again, if the user rejects the pricing or offer, the process can also log 431 the rejection to establish a record of action.

In a further instance, there may be new data available 433. For example, the OEM may make a new data set available, a new reporting speed available, a new sensor may be enabled, etc. The system can present 435 an offer of the new data to all relevant clients, along with the attendant pricing and a log of the presentation. At this point, the process can proceed in a manner similar to that which occurred when the user requests new data or a change to data.

In still other instances, there are potential legal changes 437 that may occur. Changes to laws, revisions to contract terms, changes in requirements may cause an OEM to modify a contract and seek consent from a user. In the past, it may have been difficult to prove that the user acquiesced to the new language, or that the new language was presented to the user. Using the illustrative embodiments, the process may present 439 the new legal language. The process may further log 441 any presentation of the language, as proof that the client was shown the new legal language.

If the client accepts 443 the new terms, the process can log 445 the acceptance of the terms to prove that the client accepted the new terms. If the client rejects the terms, the process can present 447 a termination disclaimer, which can be logged 449 to demonstrate that the client was expressly told that the contract would terminate if the new terms were not accepted. This gives the client a second chance to accept the new terms, and proves that the OEM did not prematurely terminate the contract without giving provable opportunity for the client to accept. If the client accepts 451, the acceptance can be recorded, otherwise the process may log 453 the termination of the contract and terminate the contract when the appropriate time period passes.

By using smart contracts enabled by blockchain, the illustrative embodiments can provide on-the-fly modification of contracts for both short and long-term durations. This helps avoid interruptions in data, and improves the record of what was shown or offered to a client, without necessarily requiring the client to sign all documents just to prove that the documents were delivered. This improved version of contract modification and handling can change the nature of data-provision negotiations and make the systems flow more cleanly and with greater and better resilient and defensible record-keeping, in addition to allowing the contracts to automatically adjust and adapt to legal and data changes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
responsive to a request for data modification, present available data options;
responsive to selection of a data option, present a consideration modification;
responsive to a user data option election, present an amended agreement reflecting the consideration modification;
responsive to user agreement to the amended agreement, create a revised document; and
create a time ordered, sequentially linked record of the request, selection, election, respective responsive presentations, agreement and creation.

2. The system of claim 1, wherein data options are drawn from a database including present data delivery options.

3. The system of claim 1, wherein the data options include types of vehicle data.

4. The system of claim 1, wherein the data options include total volume of data over a predefined time period.

5. The system of claim 1, wherein the processor is configured to include a time-ordered, sequential link to the record, of user non-agreement, responsive to a user declining the amended agreement.

6. The system of claim 1, wherein the processor is configured to detect a request for data outside the parameters of a present agreement, and treat that request for data as a request for data modification.

7. The system of claim 6, wherein a request for a data type not provided for in the agreement is treated as a request for data outside the parameters of the present agreement.

8. The system of claim 6, wherein a request for a data, after a volume of data specified by the agreement is exceeded, is treated as a request for data outside the parameters of the present agreement.

9. A method comprising:
detecting occurrence of a condition affecting one or more existing agreements;
determining to which existing agreements the condition applies;
notifying a party to the each determined agreement of a needed modification;
sending modified versions of each determined agreement reflecting the modification;
receiving acknowledgement of modified-version receipt;
receiving acceptance or rejection from the party; and
creating a time ordered, sequentially linked record of the notifying, sending, receiving acknowledgment, and receiving acknowledgement/rejection.

10. The method of claim 9, wherein the condition includes a newly available data type.

11. The method of claim 9, wherein the condition includes a change in law.

12. The method of claim 9, wherein the condition includes the party requesting a data type not specified in an existing agreement.

13. The method of claim 9, wherein the condition includes the party requesting data after a volume of data specified in an existing agreement is exceeded.

14. The method of claim 9, wherein the notifying includes sending a message to a first device pre-associated with the party and wherein the creating includes identification of the first device in the record.

15. The method of claim 14, wherein the sending includes sending the modified version to a second device pre-associated with the party and wherein the creating includes identification of the second device in the record.

16. A non-transitory computer readable storage medium storing instructions that, when executed by a processor, cause the processor to perform the method comprising:
detecting occurrence of a condition affecting one or more existing agreements;
determining to which existing agreements the condition applies;
notifying a party to the each determined agreement of a needed modification;
sending modified versions of each determined agreement reflecting the modification;
receiving acknowledgement of modified-version receipt;
receiving acceptance or rejection from the party; and
creating a time ordered, sequentially linked record of the notifying, sending, receiving acknowledgment, and receiving acknowledgement/rejection.

17. The storage medium of claim 9, wherein the condition includes a newly available data type.

18. The storage medium of claim 9, wherein the condition includes a change in law.

19. The storage medium of claim 9, wherein the condition includes the party requesting a data type not specified in an existing agreement or the party requesting data after a volume of data specified in an existing agreement is exceeded.

20. The storage medium of claim 16, wherein the notifying includes sending a message to a first device pre-associated with the party and wherein the sending includes sending the modified version to a second device pre-associated with the party and wherein the creating includes identification of both the first and second devices in the record.
